(19) United States
(12) Patent Application Publication
(10) Pub. No.: US 2014/0159445 A1
(43) Pub. Date: Jun. 12, 2014

(54) SUPPORT FOR HUMAN BODY PARTS

(71) Applicants: Felix Sam, Padova (IT); Barbara Bigolin, Asolo (Treviso) (IT)

(72) Inventors: Felix Sam, Padova (IT); Barbara Bigolin, Asolo (Treviso) (IT)

(73) Assignee: Selle Royal S.p.A., Pozzoleone (Vicenza) (IT)

(21) Appl. No.: 14/235,587

(22) PCT Filed: Jul. 30, 2012
(86) PCT No.: PCT/IB2012/053894

§ 371 Date: Feb. 19, 2014

(30) Foreign Application Priority Data
Jul. 28, 2011 (IT) VR2011A000160

(51) Int. Cl. B62J 1/00

(52) U.S. Cl. CPC B62J 1/00
USPC 297/214

(57) ABSTRACT

A support for parts of the human body, for example a bicycle saddle, padded support elements, cushions, chairs, armchairs, armrests, supports for triathlon bike handlebars, the support including a support shell, a padding positioned on said shell and a coating which covers the padding. The padding includes at least one first gel portion in the vicinity of the coating and a second foam portion in the vicinity of the support shell, the first gel portion being in the form of a layer with a progression which reproduces substantially the form of the upper supporting surface of the support. In one version at least part of this support includes a polymer material derived from renewable and/or natural sources.

### TECHNICAL FIELD

The present invention relates to a support for parts of the human body and the like, such as padded support elements, cushions, chairs, armchairs, armrests, supports for triathlon, bike handlebars and, more particularly, a bicycle saddle, to which specific reference will be made below by way of example.

### DESCRIPTION OF RELATED ART

Many designs of supports for parts of the human body are known. A particularly convenient and comfortable type of bicycle saddle, for example, is that described in EP-0903321, in the name of the same Applicant, where the comfort is ensured by the fact that the saddle is padded with gel and polyurethane foam covered by a PVC coating, known as “cover”, with a thickness of about 0.7-0.8 mm. The whole assembly rests on a plastic shell which must be connected to the bicycle frame.

A further example is that described in EP-2139751, again in the name of the same Applicant, where the saddle is composed of natural elements with a low environmental impact. In particular, this saddle has a shell made of natural fibres which are embedded in a thermoplastic or thermosetting polymer matrix and zones with varying deformibility.

However, increasingly more stringent regulations and greater sensitivity in environmental matters have led consumers to seek articles which in addition to being comfortable, are increasingly more ecological, biodegradable or able to be easily recycled or disposed of.

The saddle described in EP-0903321, for example, does not fully satisfy these requirements and the saddle in EP-2139751 does not comprise polymer materials of the polyurethane type with a low environmental impact.

Moreover, the need to reduce the overall weight of the support for parts of the human body, while maintaining good comfort characteristics and a low environmental impact, is also felt.

### SUMMARY OF THE INVENTION

One object of the present invention is to improve the prior art.

Another object of the present invention is to provide a support for parts of the human body which is improved from a comfort point of view.

A further object of the present invention is to provide a support for parts of the human body which is lighter and more economical compared to the prior art.

According to an aspect of the present invention a support for parts of the human body as specified in the present specification is provided.

The present specification further describes preferred and advantageous embodiments of the invention.

According to other aspects contained herein it is therefore possible to provide a support for parts of the human body which is improved both from an ecological point of view and as regards environmental impact owing to the use, at least partly, of materials which are derived from renewable sources and are at least partly biodegradable, easily recyclable and and/or disposable.

### BRIEF DESCRIPTION OF THE DRAWINGS

Further characteristics and advantages of the invention will emerge more clearly from the description, provided by way of example, of a bicycle saddle, together with the accompanying drawings in which:

FIG. 1 shows a perspective view of a support for parts of the human body according to the present invention;

FIG. 2 shows a longitudinally sectioned view, along the plane II-II, of the support for parts of the human body according to FIG. 1; and

FIG. 3 shows a cross-sectional view, along the plane III-III, of the support for parts or the human body according to the preceding figures.

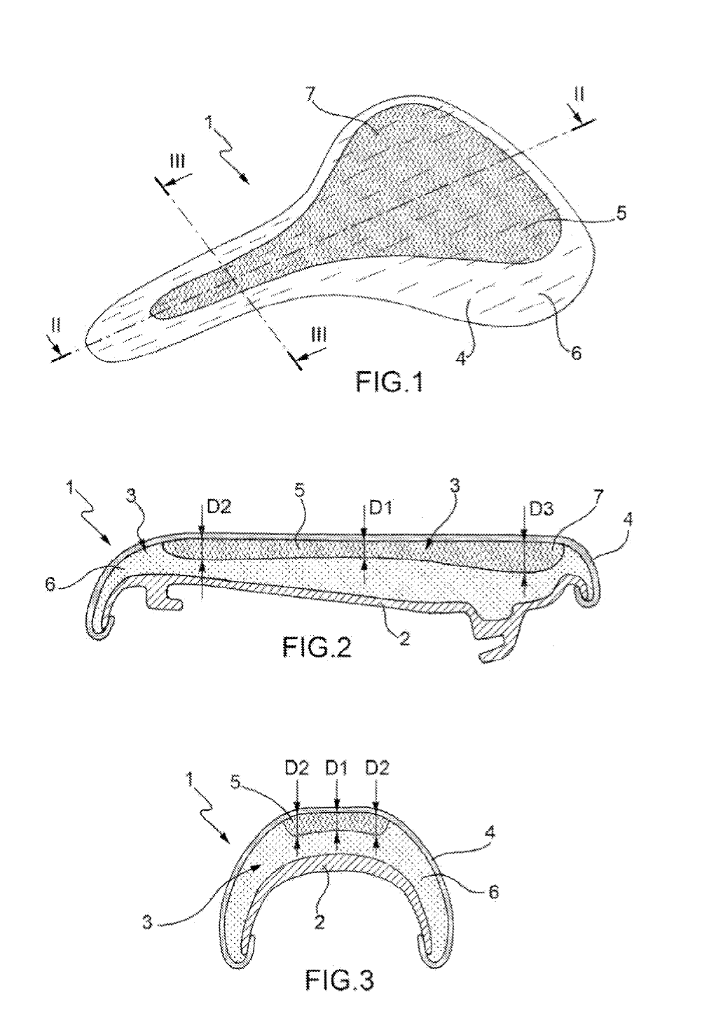

### DETAILED DESCRIPTION

A support for parts of the human body 1, such as a bicycle saddle, comprises a support shell 2 on which a padding 3, covered by an external coating 4 which may be partly or completely transparent, is mounted.

The coating 4 defines an upper continuous supporting surface, i.e., substantially smooth and avoid of discontinuities, folds, hump, and the like.

This feature makes the support, for example in the particular case in which it is constituted by a saddle for bicycle, decidedly comfortable for the user, since he does not perceive discontinuities or surface roughness which could cause discomfort to the contact.

Moreover, the continuous supporting surface, which gives a profile particularly clean and lean the support, makes the same also suitable for sports purposes, for example again in case there it is a bicycle saddle.

The padding 3 in turn comprises a first portion 5 made of polyurethane gel, placed directly in contact with the external coating 4, and a second portion 6 made of polyurethane foam, placed directly in contact with the support shell 2; the two portions 5 and 6 completely define the padding and are integral with each other, i.e. fully joined together.

An important feature of the present invention relates to the thickness of the first gel portion 5 which reproduces exactly the progression of the surface of the external coating 4 and therefore also the form of the upper supporting surface of the support for parts of the human body 1.

According to the example shown in FIGS. 2 and 3, the thickness of the layer of the first gel portion 5 is variable and more precisely from FIG. 2 it can be seen that the layer has a thickness in the centre D1, a thickness D2 at the front and at thickness D3 at the rear. Moreover, from FIG. 3 it can be noted that the layer of the first gel portion 5 has a thickness in the centre indicated by D1 and on the sides a different thickness indicated by D2.

It should be noted that the thickness of the layer of the first portion 5 may therefore be adapted to the particular comfort requirements of the different zones of the support for parts of the human body 1.

In the example shown in FIGS. 2 and 3, the thickness D1 is smaller than the thicknesses D2 and D3 and also the thickness D2 is smaller than the thickness D3.

Moreover, the parts of varying thickness axe connected together in a gradual manner.

There is therefore a substantial differentiation of the cushioning capacity provided by the first gel portion 5, with the result that the quantity of gel used for this function is also optimized.

In particular, the differentiation of the damping capacity provided by the first gel portion 5 corresponds to the different specific pressures of the user's body in the different areas of the support 1: where the specific pressure is greater, the greater the damping capacity of the first portion 5.

Basically, a thickness of gel may be distributed with a predetermined form and in the correct amount without having to define the level in relation to the plane of the free surface of the gel, i.e., the plane of the upper surface of the gel itself when it is still in the liquid state and under atmospheric pressure, and that, in the finished product, corresponds to the supporting surface with the second polyurethane-foam portion 6.

As is known, this level is determined by the horizontal plane parallel to the support plane, or reference plane, of the mould inside which the gel is cast.

In other words, the supporting surface between the first gel portion 5 and the second polyurethane-foam portion is not flat due to the leveling of the gel when it is still in liquid state—as it occurs in some supports of known type—but instead it is modeled in relation to the thickness that is intended to be realized, for example with different thicknesses in different areas. This effect is advantageously obtained in a support 1 that, as said, has the smooth outer supporting surface, i.e. without discontinuity or hump.

Owing to the smaller quantity of gel required, the saddle has a lower overall weight—it should be noted in fact that the gel has a specific weight much greater than that of foam—thus resulting also in a reduction in the overall cost of the product since foam is less expensive than gel.

Furthermore, since the gel, being a solid material, has a thermal capacity greater than that of the foam, the reduction in the amount of gel used in making the support 1 according to the invention avoids the excessively overheating of the latter due to the sun irradiation, especially for example in the case where the support is constituted by a bicycle saddle, a holder for the handlebar or the like.

In the example shown in the figures, the first portion 5 is shown as a single fraction, but obviously this first portion 5 may also consist of two or more fractions, which are for example divided up at the points supporting the pelvic bones and/or in the prostate zone.

The first portion 5 may therefore be suitably constructed so as to follow a given geometrical configuration, both in order to define preferential comfort zones and in order to enhance the aesthetic appearance.

The gel of the first portion 5 may comprise a dispersion of particles 7 with a lower specific weight than gel, for example in the form of flakes or other expanded materials or in any case low-density materials.

These particles 7 allow for further reducing the weight of the first portion 5 and also for obtaining specific comfort features.

The aforementioned particles 7 may comprise cork, and/or corn powder and/or wood dust and/or natural fibres, for example jute, cotton, etc., and/or other products which are of natural origin and/or obtained from a renewable source.

Also the gel of the first portion 5 may be obtained mainly, or entirely, from products of natural origin and/or from a renewable source, i.e., from products which are not of fossil origin.

In fact, the gel of the first portion 5 comprises a polyol component which is at least partially of natural origin and may be derived from castor oil and/or soya oil and/or palm oil and/or cardanol oil and/or corn oil and/or natural, and/or vegetable oil.

The content of the oil type determines the final characteristics of the product.

For example, the presence of castor oil in a percentage amount of between 0.1% and 50%, preferably between 5% and 40%, helps ensure the continuity of the chemical interface between the gel of the first portion 5 and the external polyurethane-film coating 4; the presence of soya, oil in a percentage amount of between 0.1% and 50% improves the properties of adhesion between the gel/coating substrates.

The presence of palm oil in an amount of between 0.1% and 50% improves the affinity between the polyurethane gel and the polyurethane foam from renewable sources and/or of natural origin, while the products derived from the processing of corn are able to regulate the degree of crosslinking of the material: increasing the quantity of products derived from corn processing increases the crosslinking of the gel and therefore its hardness.

Cardanol oil is an agricultural waste by-product obtained during the mechanical processing, for alimentary use, of cashew nut kernel which is purified and reprocessed in order to obtain a product with chemical/physical properties suitable for use in the polyurethane sector.

Said by-product, which has a chemical composition which is not well-defined, is derived from cashew nut shell and could constitute a dangerous pollutant which is difficult to dispose of, but if suitable treatment processes are adopted, it becomes an important resource which can be used as a low-cost raw material obtained from a renewable source and also provides a solution to the environmental problems associated with processing for alimentary purposes.

The polyol composition for the production of polyurethane gel may be derived either completely or partially from renewable sources and/or from natural products.

When the polyol component is 100% based on polyols from renewable sources, the composition of the resultant polyurethane gel is derived 70% to 80% from renewable sources. The second polyurethane-foam portion 6 is composed of at least 5% to 95% and preferably 20% to 80% and even more preferably 30% to 55% of a component of natural origin; any remaining part of the second portion 6 consists of polyurethane foam and/or foam of another kind, for example ethylene vinyl acetate (EVA) and/or in general comprises at least one derivative of a polymer matrix.

The natural-origin component of the second foam portion 6 comprises at least one of the following: intermediates of natural origin and/or palm oil and/or soya oil and/or castor oil and/or generally any vegetable oil, so as to maintain, even partially, the continuity of the polymer characteristics—such as the monomer sequences of the polymer—of the interfaces between the material of the natural-origin external coating 4, the polyurethane foam and the support shell 2, also of vegetable origin, in particular derived from castor oil and/or other vegetable substances.

The support shell 2 comprises at least one polymer, called RILSAN® 11 and/or, generally, polymer materials derived from renewable and/or natural sources, from castor oil and/or from other vegetable substances, for example polylactic acid. The external coating 4 may consist of polymer material, such as a polyurethane obtained completely or partially from renewable sources and/or of vegetable origin, and/or other polymer materials which are suitably treated to ensure suitable mechanical properties and resistance to atmospheric agents, such as resistance to moisture and to ultraviolet rays.

The polymer material of the external coating 4 may also comprise polyamide material, such as polyamide 11 known as PEBAX®, obtained from castor oil and/or from other vegetable substances and/or fabric and/or non-woven fabric with fibres of natural origin which are waterproofed using natural materials such as latex. The advantage obtained, in addition to that of being made of an eco-compatible material, is also that of being able to reduce the thickness of the external coating 4 to values of between 0.05 mm and 0.6 mm and preferably between 0.2 mm and 0.5 mm, improving at the same time the comfort thereof.

In fact, in this way the interference of the interface with the soft parts of the support for the parts of the human body 1 is reduced, i.e. with the first gel portion 5 and optionally with the second foam portion 6, thus increasing the sensation of comfort imparted by them and perceived by the user.

Moreover, synthetic plasticizers, the use of which will soon be banned, are eliminated from the external coating 4, resulting in an improved support for parts of the human body, having a composition of at lease 10% vegetable origin.

One part of the transparent part of the coating 4 is formed by polymer material, such as polyurethane and/or other polymer materials, and the remaining part, for example 50%, is formed by products of vegetable origin, such as the polymer called PEBAX® based on castor oil and/or another vegetable substance.

From an ecological point of view, the use of products obtained from renewable and/or natural sources per se results in a reduction in the impact on the environment due to the reduction in the use of petrochemical products from fossil sources and the consequent emission of greenhouse gases such as CO₂.

Moreover, being partly of vegetable origin, these products may be biodegradable and therefore suitably used for composting. With regards to disposal, many plastic materials may be recycled and used again.

For example, polyurethane is regenerated for carpet underlays, following grinding is introduced as a filler in novel formulations and in some cases is used in incinerators for energy recovery.

Another advantage of the present invention arises from the first gel portion 5 which has a layer with a constant or variable thickness which reproduces exactly the progression of the upper contact surface of the support for parts of the human body 1, thus optimizing the cushioning function and the quantity of gel used for this function, substantially reducing said quantity.

The invention thus conceived may be subject to numerous modifications and variations, all falling within the scope of protection of the claims.

1. Support for human body parts comprising a support body, a padding positioned on said body and a coating that covers the padding and that defines a superior continuous supporting surface, said padding including at least a first portion of polyurethane gel placed directly in contact with the coating and a second portion at least partially made from polyurethane foam placed directly in contact with the support body, said first portion of gel is in the form of a layer with a shape that substantially reproduces the shape of the upper supporting surface of the support, wherein said first portion of gel has a variable thickness, including a thickness (D1) at the center, a thickness (D2) in the front part and a thickness (D3) in the rear, said thickness (D1) being less than said front and rear thickness (D2) and (D3).

2. Support for human body parts according to claim 1, wherein at least one of said support body, said padding, and said coating comprise at least one polymeric material derived from renewable sources and/or is naturally-based.

3. Support for human body parts according to claim 1, wherein said first portion of gel has a thickness of gel according to a predetermined shape and in the correct amount without the need to define a level of a plane of the free surface of the gel, including the plane of the upper surface that the gel itself has when it is still in liquid state and under atmospheric pressure conditions.

4. Support for human body parts according to claim 1, wherein said thickness (D2) is the same of said thickness (D3).

5. Support for human body parts according to claim 1, wherein parts with different thicknesses are also gradually joined together.

6. Support for human body parts according to claim 1, wherein said first portion comprises a gel with a dispersion of particles of lower specific weight than the gel, including tufts or other expanded or low-density materials.

7. Support for human body parts according to claim 6, wherein said particles of lower specific weight than the gel comprise at least one of cork, corn powder, wood dust, and/or natural fibres, including jute, cotton, and/or other products of natural origin, and/or from a renewable source.

8. Support for human body parts according to claim 1, wherein the gel of said first portion comprises a polyol component at least partially of natural origin deriving from castor oil, and/or soybean oil, and/or palm oil, cardanol oil, corn oil and/or natural and/or vegetable-based oil.

9. Support for human body parts according to claim 8, wherein said polyol component of the gel of said first portion comprises castor oil in a percentage of between 0.1% and 50%, and preferably between 5 and 40%.

10. Support for human body parts according to claim 8, wherein said polyol component comprises soybean oil in a percentage of between 0.1 and 50%.

11. Support for human body parts according to claim 8, wherein said polyol component comprises palm oil between 0.1 and 50%.

12. Support for human body parts according to claim 8, wherein said first portion of gel comprises at least one polyisocyanate and/or polyisocyanate mixed with other isomers and/or polyisocyanate modified with naturally-based polyols.

13. Support for human body parts according to claim 1, wherein said second portion comprises at least one component of natural origin.

14. Support for human body parts according to claim 1, wherein said second portion comprises at least 5-95%, and preferably at least 20-80%, and even more preferably at least 30-55% of a component of natural origin.

15. Support for human body parts according to claim 1, wherein said portion comprises non-polyurethane foam, including ethylvinyl acetate, and/or at least one derivative of a polymeric matrix.

16. Support for seats according to claim 13, wherein said component of natural origin of said second portion comprises at least one of intermediates of natural origin, including castor oil and/or a vegetable oil.

17. Support for human body parts according to claim 1, wherein said coating comprises at least one polymer obtained from castor oil and/or from other vegetable and/or fabric and/or non-woven fabric substances.

18. Support for human body parts according to claim 17, wherein said coating has a thickness of between 0.1 mm and 0.6 mm and preferably between 0.2 mm and 0.5 mm.

19. Support for human body parts according to claim 17, wherein said coating is partially or completely transparent.

20. Support for human body parts according claim 1, wherein said support body comprises at least one polymer, including RILSAN® 11 and/or polymeric materials derived from renewable sources and/or naturally-based, derived from castor oil and/or from other vegetable substances, including polylactic acid.

21. Support for human body parts according to claim 1, wherein said first portion of gel comprises means for making said first portion of gel compatible with and/or stick to said coating and/or said second portion and/or said support body.
